(19) United States
(12) Patent Application Publication
(10) Pub. No.: US 2025/0068041 A1
(43) Pub. Date: Feb. 27, 2025

(54) CAMERA MODULE

(71) Applicant: SAMSUNG ELECTRO-MECHANICS CO., LTD., Suwon-si (KR)

(72) Inventors: Jong Won SONG, Suwon-si (KR); Tae Young CHOI, Suwon-si (KR); Young An CHOI, Suwon-si (KR)

(73) Assignee: SAMSUNG ELECTRO-MECHANICS CO., LTD., Suwon-si (KR)

(21) Appl. No.: 18/637,569

(22) Filed: Apr. 17, 2024

(30) Foreign Application Priority Data
Aug. 24, 2023 (KR) 10-2023-0111352

(51) Int. Cl. G03B 17/55; G03B 17/12

(52) U.S. Cl. CPC G03B 17/55; G03B 17/12

(57) ABSTRACT

A camera module is provided. The lens module includes a substrate on which an image sensor is disposed; a lens module, disposed in an inner housing of the camera module, and further disposed on a first surface of the substrate; and a heat transfer member, including a thermoelectric element, and disposed on a second surface of the substrate, wherein the substrate includes a heat transfer portion, wherein the heat transfer portion includes a plurality of holes which penetrate the substrate, and wherein a heat transfer material is disposed in the plurality of holes.

### CROSS-REFERENCE TO RELATED APPLICATIONS

This application claims the benefit under 35 USC § 119 (a) Korean Patent Application No. 10-2023-0111352 filed on Aug. 24, 2023, in the Korean Intellectual Property Office, the entire disclosure of which is incorporated herein by reference for all purposes.

### BACKGROUND

### 1. Field

The following description relates to a camera module.

### 2. Description of the Background

A camera module may be implemented to achieve autonomous driving or the safe operation of transportation vehicles. For example, at least one camera module may be installed outside a vehicle to provide a driver with information related to an object located in front of, or behind, the vehicle.

Camera modules that are mounted on the external body of a vehicle have increasingly been applied with an image sensor having higher resolution. As the image sensor having higher resolution is applied, an amount of heat generated by the image sensor increases, and image quality deteriorates due to the heat generated by the image sensor. Additionally, a camera mounted outside the vehicle may be directly affected by temperature and humidity depending on the driving environment of the vehicle, so there is a problem that performance of the camera may deteriorate depending on the temperature and the humidity. Therefore, a camera module that can appropriately maintain temperature and humidity therein would be beneficial.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a substrate on which an image sensor is disposed; an inner housing disposed on a first surface of the substrate; and a heat transfer member, comprising a thermoelectric element, and disposed on a second surface of the substrate, wherein a lens module is disposed in the inner housing, wherein the substrate includes a heat transfer portion, wherein the heat transfer portion comprises a plurality of holes which penetrate the substrate, and wherein a heat transfer material is disposed in the plurality of holes.

The heat transfer portion may be formed around the image sensor.

The heat transfer portion may be disposed along a lower surface of the inner housing.

The heat transfer material may be a metal material.

The metal material may be aluminum.

The heat transfer portion may overlap a lower surface of the inner housing in a direction, parallel to an optical axis.

A lower surface of the inner housing may be disposed to contact the heat transfer portion.

The camera module may further include a first lens disposed in front of the lens module, wherein an outer peripheral surface of the first lens may be disposed to contact an inner peripheral surface of the inner housing.

An outer surface of the lens module may be disposed to contact an inner surface of the inner housing.

An adhesive may be applied between the lower surface of the inner housing and the heat transfer portion.

The heat transfer member may further include a heat dissipation plate which has a first surface on which the thermoelectric element is disposed, and wherein a second surface of the heat dissipation plate may be disposed to contact the substrate.

The camera module may further include a heat dissipation pin disposed on the first surface of the heat dissipation plate.

The heat dissipation plate may be formed of a metal material.

The heat dissipation plate may be formed of aluminum.

The camera module may further include a case in which the inner housing is disposed; a temperature sensor disposed in the case; and a humidity sensor disposed in the case.

In a general aspect, a camera module includes a substrate; an inner housing disposed on a first surface of the substrate; and a heat transfer member, comprising a thermoelectric element, and disposed on a second surface of the substrate, wherein the substrate includes a heat transfer portion, wherein the heat transfer portion comprises a plurality of holes which penetrate the substrate, and wherein a heat transfer material is disposed in the plurality of holes to thermally connect the inner housing to the heat transfer member.

The camera module may further include a lens barrel disposed in the inner housing; and an image sensor disposed on the substrate.

The lens barrel may be coupled to the inner housing.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates a cross-sectional view of an example camera module, in accordance with one or more embodiments.

FIG. 3 illustrates an exploded perspective view of a portion of an example camera module, in accordance with one or more embodiments.

FIG. 4 illustrates an enlarged cross-sectional view of a portion of an example camera module, in accordance with one or more embodiments.

FIG. 5 illustrates a substrate of an example camera module, in accordance with one or more embodiments, as seen from an object side.

FIG. 6 illustrates a structure in which heat transfer materials are arranged on a substrate, in accordance with one or more embodiments.

FIG. 7 illustrates a cross-sectional view of an example camera module, in accordance with one or more embodiments.

FIG. 8 illustrates an enlarged cross-sectional view of a portion of an example camera module, in accordance with one or more embodiments.

FIG. 9 illustrates a cross-sectional view of an example camera module, in accordance with one or more embodiments.

FIG. 10 illustrates an enlarged cross-sectional view of a portion of an example camera module, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

A camera module described herein may be configured to be mounted on a vehicle, for example, a transportation vehicle, as a non-limiting example. For example, the camera module, in accordance with one or more embodiments, may be mounted in the form of a front and/or rear surveillance camera or an autonomous driving camera in a car, a truck, a freight vehicle, a fire truck, a forklift, etc. However, the scope and examples of implementing the camera module described in the one or more examples are not limited to the devices described above. For example, the camera module may be mounted in the form of a camera for imaging, such as a surveillance drone, a transport drone, or the like, but not limited thereto.

One or more examples provide a camera module that may appropriately maintain temperature and humidity therein.

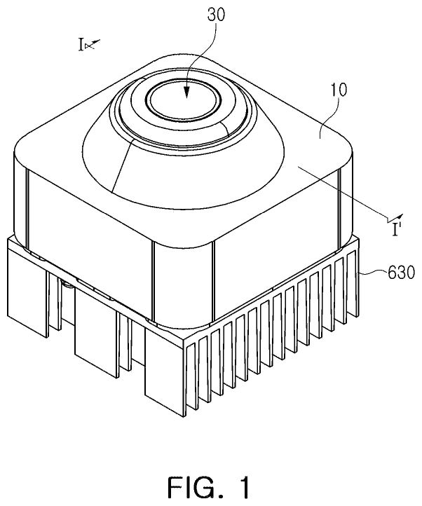

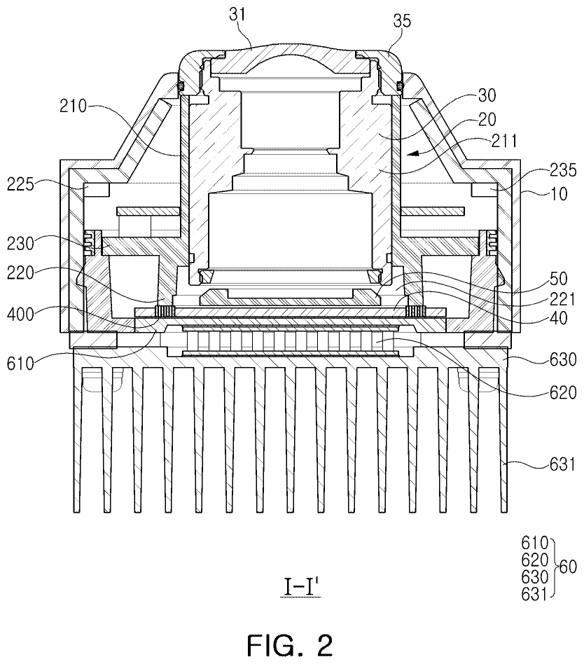

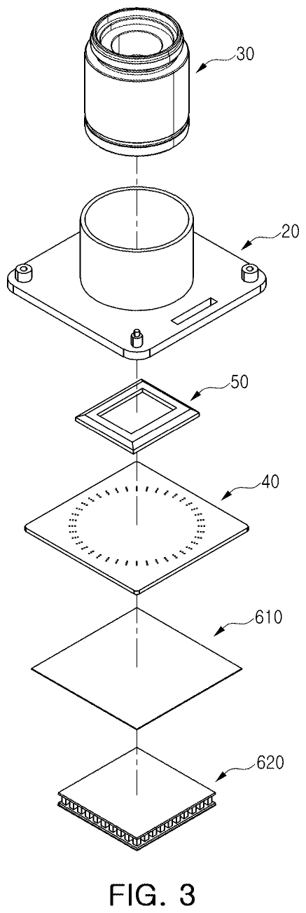

FIG. 1 illustrates a perspective view of an example camera module, in accordance with one or more embodiments, FIG. 2 illustrates a cross-sectional view of an example camera module, in accordance with one or more embodiments, and FIG. 3 is an exploded perspective view illustrating a portion of an example camera module, in accordance with one or more embodiments.

In an example, a camera module, in accordance with one or more embodiments, may include a case 10, an inner housing 20, a lens module 30, and a substrate 40.

The case 10 may form an exterior of the camera module. The case 10 may be disposed in an outermost portion of the camera module. A temperature sensor 225, a humidity sensor 235, the inner housing 20, the lens module 30, and the substrate 40 may be disposed in the case 10.

The temperature sensor 225 and the humidity sensor 235 may be disposed in the case 10, and locations thereof are not limited to specific locations. The temperature sensor 225 and the humidity sensor 235 may detect the temperature and the humidity in the case 10, respectively, and an operation of a thermoelectric element 620 may be determined based on the temperature and the humidity respectively detected by the temperature sensor 225 and the humidity sensor 235.

The inner housing 20 may be disposed inside the case 10. The lens module 30, which will be described later, may be inserted into the inner housing 20. The inner housing 20 may support the lens module 30 in the case 10. The inner housing 20 may be disposed on, or above, the substrate 40, which will be described later. The inner housing 20 may be disposed to be in direct contact with the substrate 40.

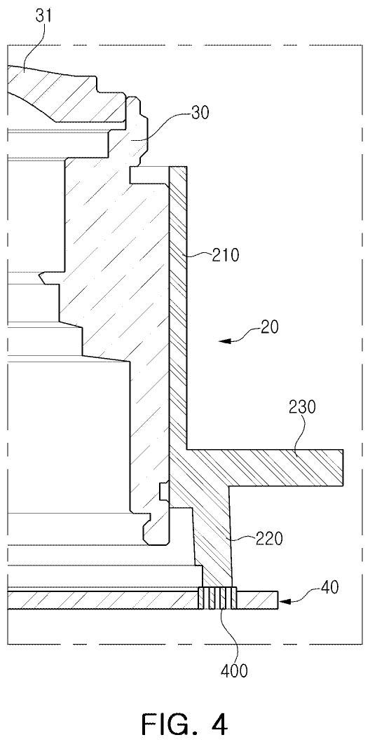

FIG. 4 illustrates an enlarged cross-sectional view of a portion of an example camera module, in accordance with one or more embodiments.

An inner housing 20 may include a first body 210, a second body 220, and a support portion 230. The first body 210, the second body 220, and the support portion 230 may be formed to be integrated. The first body 210, the support portion 230, and the second body 220 may be sequentially arranged in an optical axis direction. The first body 210 may be disposed on a first side of the support portion 230, and the second body 220 may be disposed on a second side of the support portion 230. The first side and the second side of the support portion 230 may be disposed in opposite directions.

The first body 210 may have a cylindrical shape including a first hole 211. A lens module 30 may be inserted into the first hole 211 of the first body 210. In an example, an outer radius of the first body 210 may be less than an outer radius of the second body 220. A radius of the first hole 211 of the first body 210 may be less than a radius of a second hole 221 of the second body 220, which will be described later.

In an example, the support portion 230 may be a flat plate including a third hole. The third hole formed in the support portion 230 may be a hole having a circular cross-section. In a non-limited example, a radius of the third hole may be the same as the radius of the first hole 211. In a non-limited example, the support portion 230 may be in contact with a case 10. The inner housing 20 may be supported in the case 10 by the support portion 230.

The second body 220 may have a cylindrical shape including the second hole 221. The outer radius of the second body 220 may be larger than the outer radius of the first body 210. The radius of the second hole 221 may be larger than the radius of the first hole 211. A lower surface of the second body 220 may be disposed on a substrate to be described later. The lower surface of the second body 220 may be disposed to contact a heat transfer portion 400 of the substrate, which will be described later.

The lens module 30 may include a plurality of lenses and a lens barrel. The lens module 30 may include a lens assembly including the plurality of lenses. The lens module 30 may be inserted into the inner housing 20. An outer surface of the lens module 30 may be disposed to contact an inner surface of the inner housing 20. The lens module 30 may be optically aligned with an image sensor 50, which will be described later. The lenses included in the lens module 30 may be lenses formed of a plastic material.

The heat transfer portion 400 of the substrate 40 may be disposed to contact a lower surface of the inner housing 20, and the outer surface of the lens module 30 may be in contact with the inner surface of the inner housing 20. Therefore, when the heat transfer portion 400 is heated or cooled, the inner housing 20 may be heated or cooled by the heat transfer portion 400, and the lens module 30 may be heated or cooled by the inner housing 20. Accordingly, the lenses disposed on the lens module 30 may also be maintained at an appropriate temperature by heating or cooling the heat transfer portion 400.

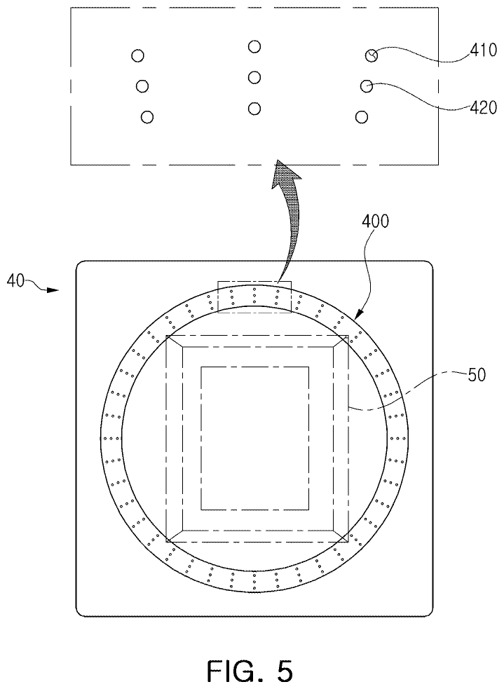

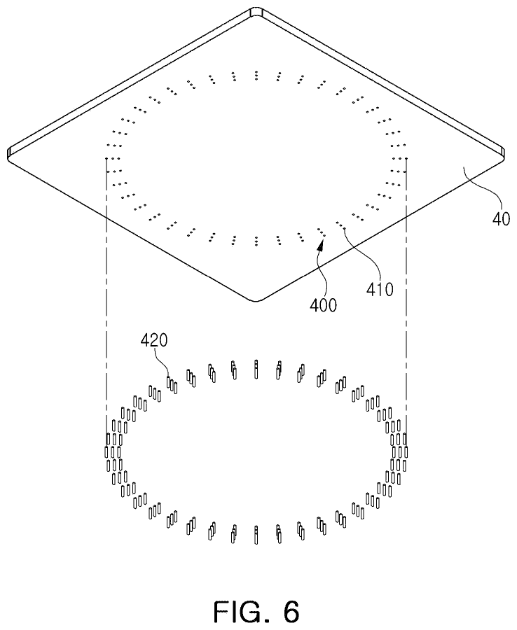

FIG. 5 illustrates a substrate of an example camera module, in accordance with one or more embodiments, as seen from an object side, and FIG. 6 illustrates a structure in which heat transfer materials are arranged on a substrate, in accordance with one or more embodiments.

In an example, a substrate 40 may be a printed circuit board. The substrate 40 may be disposed in a case 10. In an example, the substrate 40 may be disposed behind an inner housing 20. In an example, the substrate 40 may be disposed on an image side, based on a lens module 30. An image sensor 50 may be disposed on the substrate 40. A first surface of the substrate 40 on which the image sensor 50 is disposed may be disposed on an object side, based on the substrate 40. A heat transfer member 60 may be disposed on a second surface of the substrate 40. The heat transfer member 60 may be disposed to contact the second surface of the substrate 40.

The heat transfer member 60 may include a heat dissipation plate 610, a thermoelectric element 620, and a heat dissipation pin 630. The thermoelectric element 620 may be disposed between the heat dissipation plate 610 and the heat dissipation pin 630. The heat dissipation plate 610 may have a flat plate shape. In a non-limited example, the heat dissipation plate 610 may be formed of metal. The heat dissipation plate 610 may be formed of a metal having high thermal conductivity. The heat dissipation plate 610 may be formed of gold, aluminum, or copper, as non-limited examples.

One surface of the heat dissipation plate 610 may be in contact with the second surface of the substrate 40. Heat from the thermoelectric element 620 may be transferred to the substrate 40 through the heat dissipation plate 610. The heat from the thermoelectric element 620 may be transferred to a large region through the heat dissipation plate 610.

The thermoelectric element 620 may be an element that is heated or cooled using electrical energy. The heat dissipation plate 610 may be disposed on a first side of the thermoelectric element 620, and the heat dissipation pin 630 may be disposed on a second side of the thermoelectric element 620.

When the first side of the thermoelectric element 620 is heated, the second side of the thermoelectric element 620 may be cooled. Conversely, when the first side of the thermoelectric element 620 is cooled, the second side of the thermoelectric element 620 may be heated. When a temperature of a camera module is lower than an appropriate temperature, the first side of the thermoelectric element 620 may be heated to heat the camera module. When the temperature of the camera module is higher than the appropriate temperature, the first side of the thermoelectric element 620 may be cooled to cool the camera module.

The heat dissipation pin 630 may include a plurality of pins 631. The heat dissipation pin 630 may be formed of a metal material. A material of the heat dissipation pin 630 may be formed of, as non-limited examples, gold, aluminum, or copper. The heat dissipation pin 630 may transfer heat generated from the thermoelectric element 620 externally.

When the camera module is cooled by the thermoelectric element 620, the first side of the thermoelectric element 620 may be cooled, and the second side of the thermoelectric element 620 may be heated. In this example, heat generated from the second side of the thermoelectric element 620 may be emitted externally through the heat dissipation pin 630. Accordingly, a difference in temperature between the first side and the second side of the thermoelectric element 620 may be appropriately maintained.

When the camera module is heated by the thermoelectric element 620, the first side of the thermoelectric element 620 may be heated and the second side of the thermoelectric element 620 may be cooled. In this example, heat in the air may be transferred to the second side of the thermoelectric element 620 through the heat dissipation pin 630. Therefore, a difference in temperature between the first side of the thermoelectric element 620 and the second side of the thermoelectric element 620 may be appropriately maintained.

In an example, the substrate 40 may be a printed circuit board. The image sensor 50 may be disposed on a first side of the substrate 40. The heat transfer member 60, described above, may be disposed on the second side of the substrate 40.

In an example, a heat transfer portion 400 may be disposed in the substrate 40. In an example, the heat transfer portion 400 may have a ring shape. However, this is only an example, and the heat transfer portion 400 may be implemented in various other shapes. When viewed from an upper portion above the substrate, the heat transfer portion 400 may be disposed around the image sensor 50. The heat transfer portion 400 may include a plurality of holes 410 that penetrate the substrate 40. In an example, the plurality of holes 410 may be arranged in a ring shape. The plurality of holes 410 may be arranged in a ring shape around the image sensor 50. The plurality of holes 410 may be arranged to be spaced apart from each other.

Referring to FIG. 6, the plurality of holes 410 may be filled with a heat transfer material 420. In an example, the heat transfer material 420 may be metal. In an example, the metal filled in the plurality of holes 410 may be gold, aluminum, or copper, as non-limited examples.

The heat transfer portion 400 may be in contact with the inner housing 20 on the first side of the substrate 40. At least a portion of a lower surface of the inner housing 20 may be in contact with at least a portion of the heat transfer portion 400. An adhesive may be applied between the heat transfer portion 400 and the lower surface of the inner housing 20. The inner housing 20 and the substrate 40 may be firmly coupled to each other using the adhesive. When the inner housing 20 is formed of metal, the heat transfer portion 400 and the lower surface of the inner housing 20 may be joined by a solder.

On the second side of the substrate 40, the heat transfer portion 400 may be in contact with the heat dissipation plate 610 of the heat transfer member 60.

The heat transfer portion 400 may be heated or cooled by the thermoelectric element 620 of the heat transfer member 60. An internal space of the inner housing 20 may be heated or cooled by the heat transfer portion 400 through convection and radiation. Additionally, since the heat transfer portion 400 and the lower surface of the inner housing 20 may be disposed to contact each other, the inner housing 20 may be heated or cooled through conduction.

When the inner housing 20 is heated or cooled, the lens module 30 disposed in the inner housing 20 may also be heated or cooled.

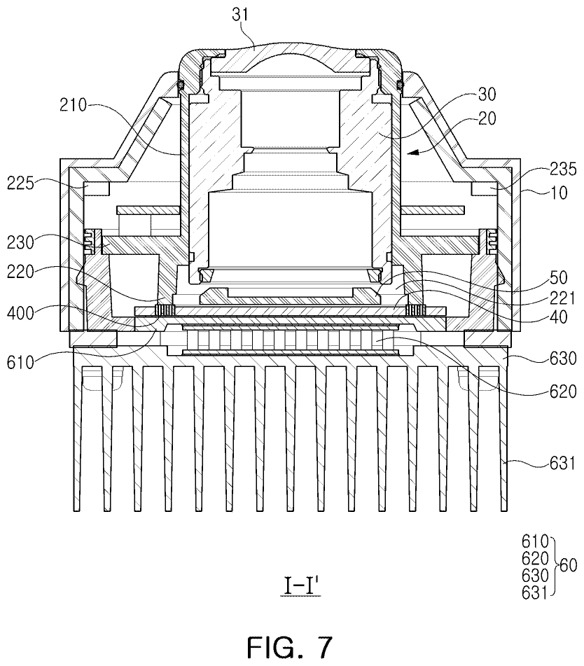

Hereinafter, another embodiment of a camera module according to the present disclosure will be described with reference to FIGS. 7 to 10. Description for the contents, identical to those of the embodiments, previously described, will be omitted, and differences therein will be mainly described.

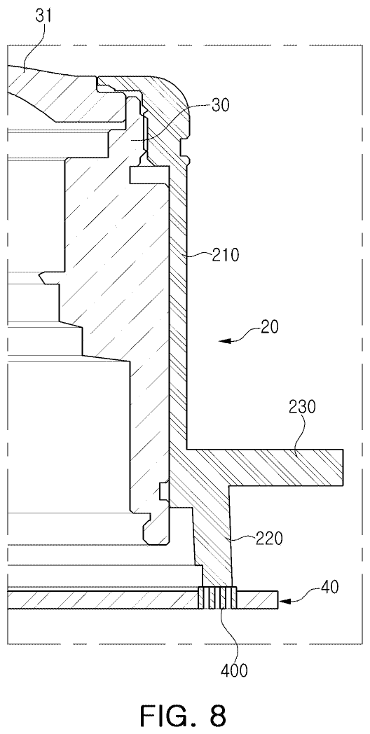

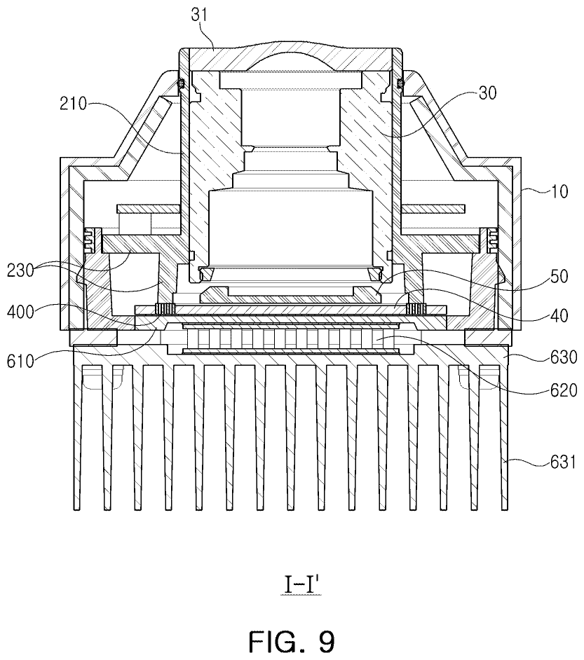

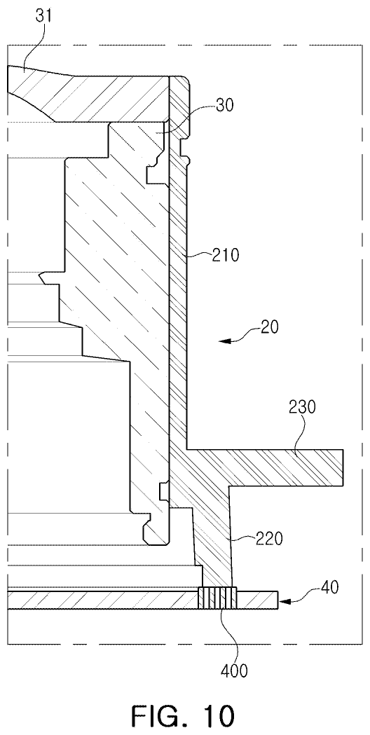

FIG. 7 is a cross-sectional view of an example camera module, in accordance with one or more embodiments. FIG. 8 is an enlarged cross-sectional view of a portion of an example camera module, in accordance with one or more embodiments. FIG. 9 is a cross-sectional view of an example camera module, in accordance with one or more embodiments. FIG. 10 is an enlarged cross-sectional view of a portion of an example camera module, in accordance with one or more embodiments.

Referring to FIGS. 7 to 10, a lens barrel 30 may be disposed inside an inner housing 20, in accordance with one or more embodiments. Additionally, a first lens 31 may be disposed in front of the lens barrel 30. The lens barrel 30 and the first lens 31 may be coupled to the inner housing 20. Alternatively, the lens barrel 30 and the first lens 31 may be inserted into and disposed in a hole formed in the inner housing 20.

In an example, the first lens 31 may be a cover lens. The first lens 31 may refer to a lens disposed in a most front portion of a camera module, closer to an object. Therefore, a surface of the first lens 31 facing an object side may be exposed to the atmosphere. A material of the first lens 31 may be glass or plastic, as only examples. A side surface of the first lens 31 may be disposed to be in direct contact with an inner surface of the inner housing 20. To couple the first lens 31 and the inner housing 20, an adhesive may be applied between the side surface of the first lens 31 and the inner surface of the inner housing 20. In an alternative manner, the first lens 31 and the inner housing 20 may be coupled by a screw, or the first lens 31 and the inner housing 20 may be forcedly coupled by insertion. A coupled structure of the first lens 31 and the inner housing 20 may include various examples other than the examples above, but it is desirable that at least a portion of the first lens 31 and at least a portion of the inner housing 20 are coupled to in direct contact with each other.

A substrate 40 may be disposed on a lower side of the inner housing 20. A lower surface of the inner housing 20 may be disposed to contact an upper surface of the substrate 40. Specifically, the lower surface of the inner housing 20 may be disposed to contact a heat transfer portion 400 of the substrate 40. Accordingly, when the heat transfer portion 400 is heated or cooled by a thermoelectric element 620, the inner housing 20 may be heated or cooled.

When the inner housing 20 is heated or cooled by the heat transfer portion 400, the first lens 31 may be heated or cooled by the inner housing 20. Since the surface of the first lens 31 facing an object side is exposed externally, condensation may occur on a surface of the first lens 31 facing an image side depending on a change in external temperature. When condensation occurs on the surface of the first lens 31 facing an image side, the first lens 31 may be heated or cooled by heating or cooling the inner housing 20 to remove the condensation.

An example camera module, in accordance with one or more embodiments, may have advantages of maintaining temperature and humidity in a camera module based on the operation of a heat transfer member 60 in an appropriate level.

According to one or more examples, a camera module that may appropriately maintain temperature and humidity in the camera module to secure image quality may be provided.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a substrate on which an image sensor is disposed;
an inner housing disposed on a first surface of the substrate; and
a heat transfer member, comprising a thermoelectric element, and disposed on a second surface of the substrate,
wherein a lens module is disposed in the inner housing,
wherein the substrate includes a heat transfer portion,
wherein the heat transfer portion comprises a plurality of holes which penetrate the substrate, and
wherein a heat transfer material is disposed in the plurality of holes.

2. The camera module of claim 1, wherein the heat transfer portion is formed around the image sensor.

3. The camera module of claim 2, wherein the heat transfer portion is disposed along a lower surface of the inner housing.

4. The camera module of claim 1, wherein the heat transfer material is a metal material.

5. The camera module of claim 4, wherein the metal material is aluminum.

6. The camera module of claim 1, wherein the heat transfer portion overlaps a lower surface of the inner housing in a direction, parallel to an optical axis.

7. The camera module of claim 1, wherein a lower surface of the inner housing is disposed to contact the heat transfer portion.

8. The camera module of claim 7, further comprising a first lens disposed in front of the lens module,
wherein an outer peripheral surface of the first lens is disposed to contact an inner peripheral surface of the inner housing.

9. The camera module of claim 7, wherein an outer surface of the lens module is disposed to contact an inner surface of the inner housing.

10. The camera module of claim 7, wherein an adhesive is applied between the lower surface of the inner housing and the heat transfer portion.

11. The camera module of claim 1, wherein the heat transfer member further comprises a heat dissipation plate which has a first surface on which the thermoelectric element is disposed, and
wherein a second surface of the heat dissipation plate is disposed to contact the substrate.

12. The camera module of claim 11, further comprising a heat dissipation pin disposed on the first surface of the heat dissipation plate.

13. The camera module of claim 11, wherein the heat dissipation plate is formed of a metal material.

14. The camera module of claim 11, wherein the heat dissipation plate is formed of aluminum.

15. The camera module of claim 1, further comprising:
a case in which the inner housing is disposed;
a temperature sensor disposed in the case; and
a humidity sensor disposed in the case.

16. A camera module, comprising:
a substrate;
an inner housing disposed on a first surface of the substrate; and
a heat transfer member, comprising a thermoelectric element, and disposed on a second surface of the substrate,
wherein the substrate includes a heat transfer portion,
wherein the heat transfer portion comprises a plurality of holes which penetrate the substrate, and
wherein a heat transfer material is disposed in the plurality of holes to thermally connect the inner housing to the heat transfer member.

17. The camera module of claim 16, further comprising:
a lens barrel disposed in the inner housing; and
an image sensor disposed on the substrate.

18. The camera module of claim 17, wherein the lens barrel is coupled to the inner housing.
